(19) United States
(12) Patent Application Publication
(10) Pub. No.: US 2002/0193141 A1
(43) Pub. Date: Dec. 19, 2002

(54) Bracket for a personal digital assistant with the function of a digital camera

(76) Inventor: Yaz-Tzung Wu, Taipei (TW)

Correspondence Address: BACON & THOMAS, PLLC, 625 SLATERS LANE, FOURTH FLOOR, ALEXANDRIA, VA, 22314

(21) Appl. No.: 09/882,179

(22) Filed: Jun. 18, 2001

(51) Int. Cl. H04B 7/00

(52) U.S. Cl. 455/556; 455/550; 455/90; 455/66

(57) ABSTRACT

The present invention is a bracket for a personal digital assistant (PDA) with the function of a digital camera, in which an image capture device is mounted inside the bracket of the said PDA, one side of the said bracket is disposed with a recessed slot just enough for accommodating the said PDA, thereby when the said PDA is inserted in the recessed slot of the said bracket and electrically connected with the said bracket, a central processing unit (CPU) of the said PDA is capable of reading the digital image signals captured by the said image capture device and storing the same a memory of the said PDA, and letting said PDA be used as a digital camera.

### BACKGROUND OF THE INVENTION

1) Field of the Invention

The present invention relates to the field of a bracket for a personal digital assistant and more particularly to a bracket for a personal digital assistant with the function of a digital camera.

2) Description of the Prior Art

Along with the global extensity and availability of the Internet, the information exchange industry has been developed tremendously, the fast transmission of the media enables the already rapidly developed products of the electronic devices, such as the personal digital assistant (PDA) and the hand-held personal computer (HPC) advance even further; that the volume of the PDA becomes smaller and smaller and the content thereof increases more and more makes the hand-held information device, such as HPC which is easy to carry, super thin, delicate, practical, easy to move and in possession of all the functions, become even more threatening.

Accordingly, a PDA available on the present market is shown in FIG. 1, the said PDA (1) is disposed with a bracket (11) for inserting the said PDA (1), a insert seat (13) just for accommodating the said PDA (1) is mounted on the said bracket (11); the said insert seat (13) inclines to a certain angle, a connecting port (15) is disposed on the bottom edge of the said insert seat (13), a coupling joint (16) is mounted at the position where the said PDA (1) corresponds to the said connecting port (15); the insertion of the said PDA (1) on the said insert seat (13) makes the coupling joint (16) couple onto the said connecting port (15), thereby enables the said PDA (1) and the said bracket (11) to achieve electric connection; the back side of the said insert seat (13) is disposed with a back stand (17) to make the said insert set (13) stand more stably on a bottom seat (18) of the said bracket (11); inside the said bracket (11), a charge circuit and a connecting port to be connected to the computer are mounted respectively, wherein, the said charge circuit connects with an external power source, therefore, when the said PDA (1) is inserted onto the said insert seat (13), a charge battery of the said PDA (1) is charged via the said charge circuit, at the mean time, a bus cable with one end coupled onto the said connecting port and the other end connected with the computer enables the said PDA (1) to connect with the said computer for inter-transmitting information.

However, since the said traditional PDA (1) can't be used as a digital camcorder; when trying to photograph, an additional card-inserted digital camera is to be purchased; therefore, when going outdoors, in addition to the said PDA (1) and the bracket (11), another card-inserted digital camera is to be carried also for photographing and that is very inconvenient.

### SUMMARY OF THE INVENTION

It is therefore an object of the present invention to provide a bracket for a personal digital assistant (PDA) with the function of a digital camera, in which an image capture device is mounted inside the bracket of the said PDA, one side of the said bracket is disposed with a recessed slot just enough for accommodating the said PDA, one side of the said recessed slot is mounted with a connector, a connecting port is disposed at the position where the said PDA corresponds to the said connector for the user to insert the said PDA in the recessed slot of the said bracket, thereby when the said PDA is inserted in the recessed slot of the said bracket to make the said connecting port couple onto the said connector, a central processing unit (CPU) of the said PDA connects with an image capture control circuit of the said image capture device via an interface circuit to conduct image capturing through a set of optical components of the said image capture device and to enable the CPU of the said PDA to read the digital image signals captured by the said image capture device to be stored in a memory of the said PDA, therefore, the said PDA is used as a digital camera and the user does not have to purchase another card-inserted digital camera.

### BRIEF DESCRIPTION OF THE DRAWINGS

FIG. 1 is a perspective view of a bracket for a personal digital assistant in the prior art.

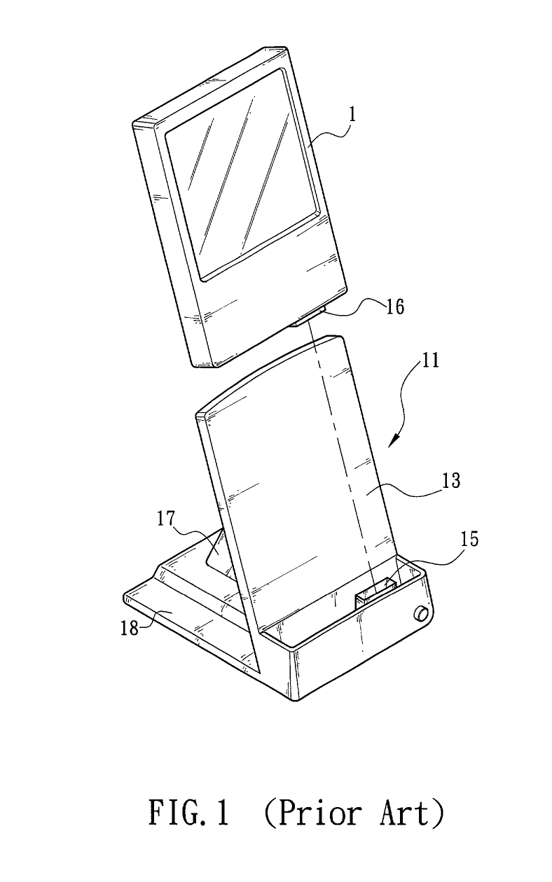

FIG. 2 is an exploded view of a preferred embodiment of a bracket for a personal digital assistant according to the invention.

FIG. 3 is a perspective view of the bracket being connected with the personal digital assistant according to the invention.

FIG. 4 is a schematic block diagram of the bracket being connected with the personal digital assistant according to the invention.

FIG. 5 is a side view of another preferred embodiment of the bracket being connected with the personal digital assistant according to the invention.

### DETAILED DESCRIPTION OF THE PREFERRED EMBODIMENTS

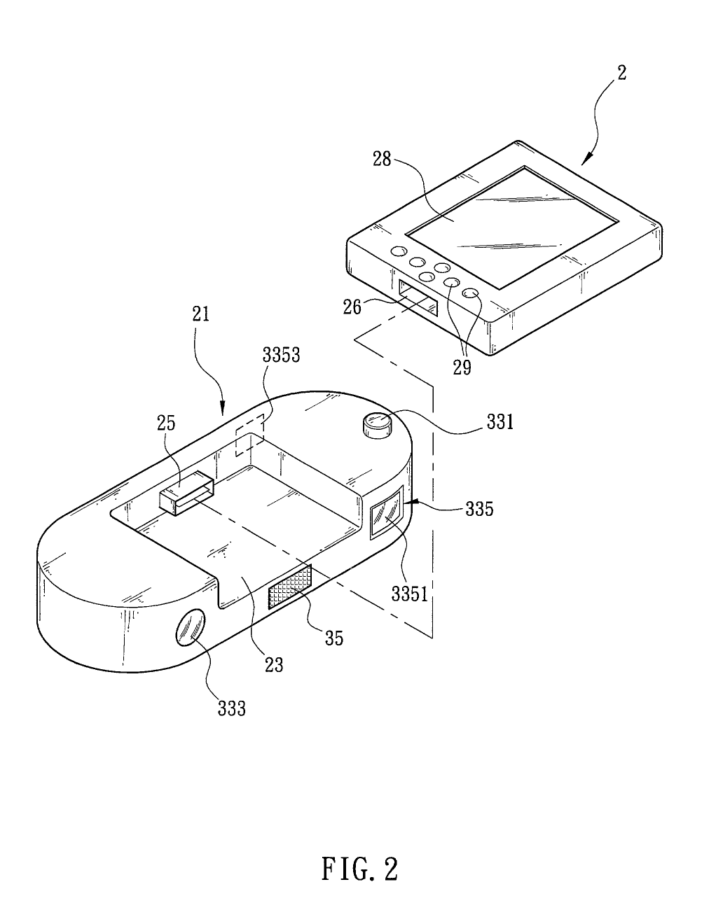

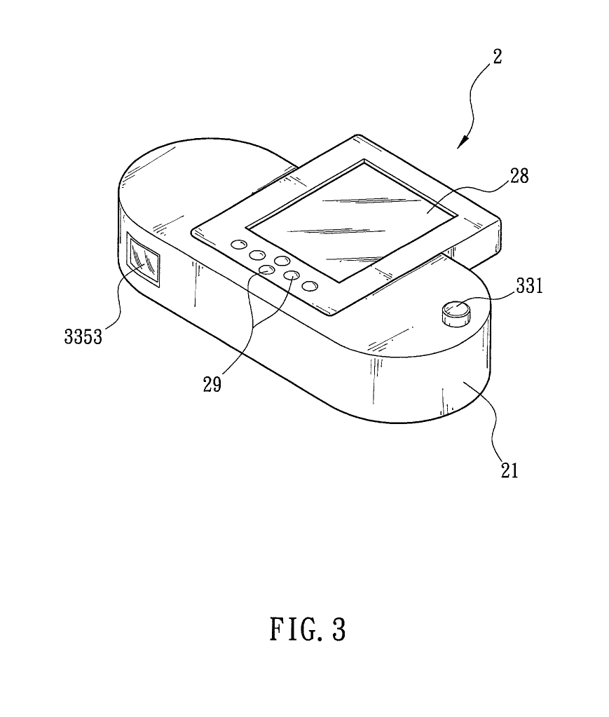

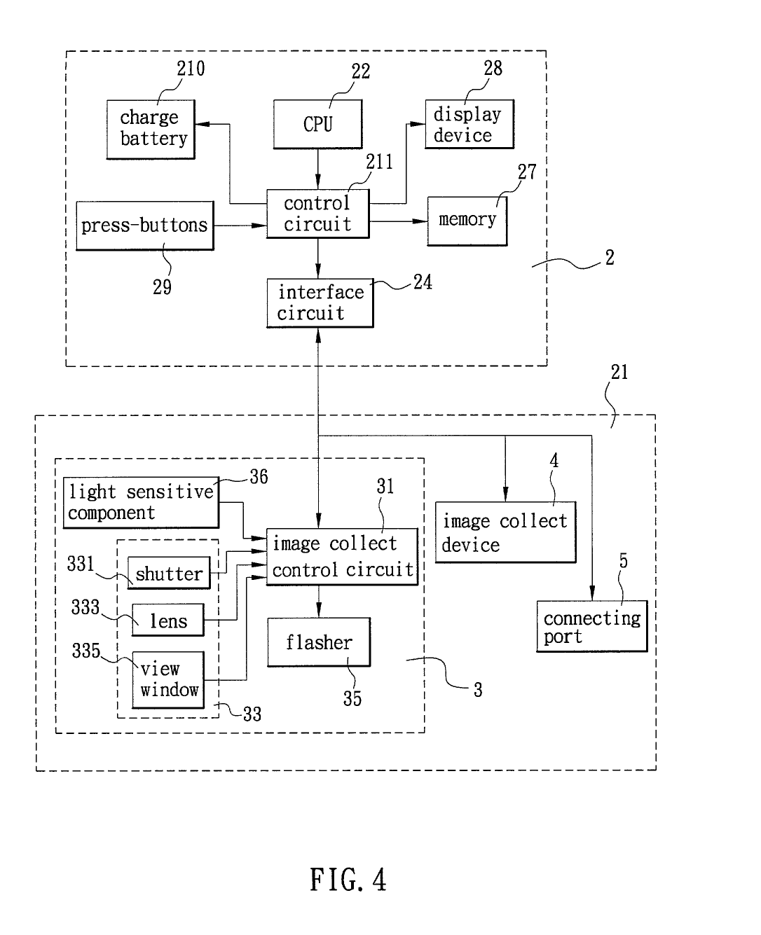

The present invention is a bracket for a personal digital assistant (PDA) with the function of a digital camera, as shown in FIGS. 2 and 4, an image capture device (4) is mounted inside the bracket (21) of the said PDA (2), one side of the said bracket (21) is disposed with a recessed slot (23) just enough for accommodating the said PDA (2), one side of the said recessed slot (23) is mounted with a connector (25), a connecting port (26) is disposed at the position where the said PDA (2) corresponds to the said connector (25) for the user to insert the said PDA (2) in the recessed slot (23) of the said bracket (21), thereby when the said connecting port (26) is coupled to the said connector (25), as shown in FIG. 3, the central processing unit (CPU) (22) of the said PDA (2) connects with an image capture control circuit (31) of the said image capture device (3) via an interface circuit (24) to conduct image capturing through a set of optical components (33) of the said image capture device (3) and to enable the CPU (22) of the said PDA (2) to read the digital image signals captured by the said image capture device (3) to be stored in a memory (27) of the said PDA.

Referring again to FIGS. 2 and 4, in the present invention, a display device (28) on the housing of the said PDA (2), a set of press-buttons (29) on one side of the said display device (28) as well as a charge battery (210) and the said memory (27) inside the said PDA (2) are all connected with the said CPU (22) via a control circuit (211), thereby the CPU (22) follows the programming commands stored inside the memory (27) thereof to execute the control processing for every component on the said PDA (2).

Referring again to FIGS. 2 and 4, in the present invention, a charge circuit (4) is disposed inside the said bracket (21), the said charge circuit (4) connects with an external power source via a guide wire, therefore, when the said PDA (2) is inserted in the recessed slot (23) of the said bracket (21) to make the said connector (25) couple onto the said connecting port (26), the said charge circuit (4) connects with the said interface circuit (24) and the control circuit (211) for conducting the charging for the said charge battery (210); a connecting port (5) is disposed inside the said bracket (21) and that makes the said bracket (21) connect with a computer via the said connecting port (5).

Referring again to FIGS. 2 and 4, in the present invention, the said set of optical components (33) comprises of a shutter (331), a lens (333) and a view window (335), wherein, the said shutter (331) is disposed on the holder section on the housing of the said bracket (21) to allow the user's finger to touch and press the said shutter (331); the said lens (333) is mounted on one lateral side on the housing of the said bracket (21), the said lens (333) photographs the image into the said image capture control circuit (31) to make the said image capture control circuit (3 1) compile the photographed image to a digital signal; the said view window (335) is disposed on the other lateral side of the said lens (333), the said view window (335) has an outer view window (3351) and an inner view window (3353) mounted respectively on the front and the rear sides of the said bracket (21), the said outer view window (3351) and the inner view window (3353) are communicated, thereby one of the user's eyes attaches closely to the said inner view window (3353) to view the object to be photographed outside the said outer view window (3351).

Referring again to FIGS. 2 and 4, in the present invention, the said image capture device (3) also comprises of a flasher (35) and a light sensitive component (36), the said flasher (35) and the light sensitive component (36) connect with the said image capture control circuit (31) to enable the said image capture control circuit (31) to receive the light sensitive signals of the said light sensitive component (36) to control the said flasher (35) to conducts the flashing; the said flasher (35) is disposed between the said lens (333) and the said view window (335) on the housing of the said bracket (21); the said light sensitive component (36) is mounted on one lateral side adjacent to the said flasher (35) to enable the said light sensitive component (36) to test the light source around the object to be photographed and to enable the said image capture control circuit (31) to receive the light sensitive signals of the said light sensitive component (36), thereby to control the said flasher (35) to conduct the flashing to supplement enough light for the object to be photographed.

By virtue of the assembly of the mentioned components, when the user insert the said PDA (2) in the recessed slot (23) of the said bracket (21) to make the said connector (25) couple onto the said connecting port (26), he uses the said image capture device (3) to aim the said lens (333) at the object to be photographed and depresses the said shutter (331) to enable the said lens (333) to photograph the object to be photographed into the said image capture control circuit (31) to be compiled to a digital signal and to enable the CPU (22) of the said PDA (2) to read the digital image signal captured by the image capture device (3) to be stored in a memory (27) of the said PDA (2).

When the user wants to view the product of photographing, he selects the image display items of the said PDA (2) to make the CPU (22) of the said PDA (2) read the digital image signal pre-stored inside the said memory (27) and to make the said display device (28) display the image.

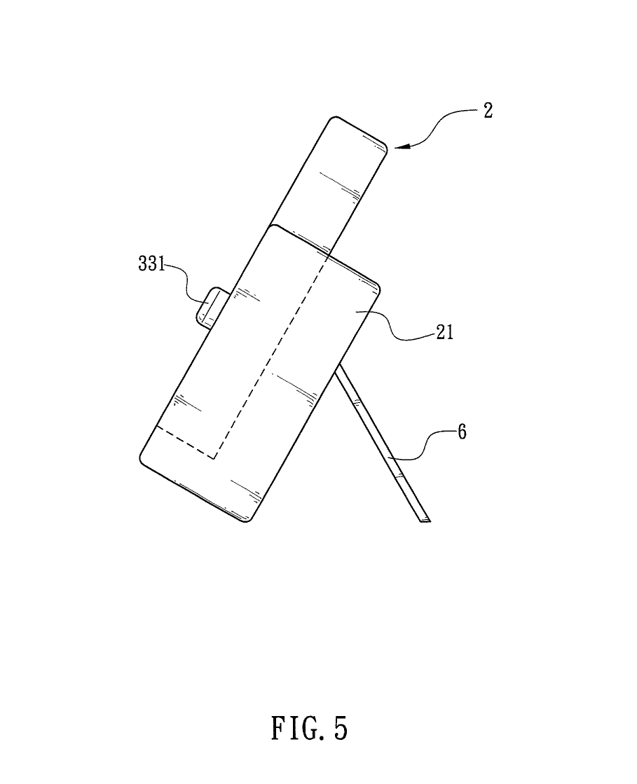

In another preferred embodiment of the present invention, as shown in FIG. 5, a supporting pedestal (6) is pivotally mounted at the proper position on the back side of the said bracket (21), a stop component is mounted at the pivotal joint area between the said pedestal (6) and the said bracket (21), the stopping of the said stop component on the said bracket (21) permits the said pedestal (6) to be only lifted outward to a proper angle, thereby the user can lift the said pedestal (6) outward to make the said bracket (21) stand on a flat plane through the supporting force of the said pedestal (6).

Therefore, the said PDA (2) can be used as a digital camera and the user does not have to purchase an additional card-inserted digital camera.

1. A bracket for a personal digital assistant (PDA) with the function of a digital camera comprises of:
a bracket with a recessed slot disposed near the central position on one side of the said bracket, the said recessed slot is enough just for accommodating a PDA, thereby a connector mounted on one side of the recessed slot just connects a corresponding connecting port disposed on the said PDA;
an image capture device mounted inside the said bracket and is disposed with an image capture control circuit and a set of optical components, thereby when the said PDA is inserted in the recessed slot of the said bracket and the said connecting port is coupled onto the said connector, a central processing unit (CPU) of the said PDA connects with an image capture control circuit of the said image capture device via an interface circuit, thereby the image capturing is conducted by means of the said set of optical components controlled by the said image capture control circuit, and thereby the CPU of the said PDA reads the digital image signals captured by the said image capture device to be stored in a memory of the said PDA.

2. A bracket for a personal digital assistant (PDA) with the function of a digital camera according to claim 1, wherein a charge circuit is disposed inside the said bracket, the said charge circuit connects with an external power source via a guide wire, therefore, when the said PDA is inserted in the recessed slot of the said bracket to make the said connector couple onto the said connecting port, the said charge circuit connect with the said interface circuit and the control circuit to conduct the charging for the said charge battery.

3. A bracket for a personal digital assistant (PDA) with the function of a digital camera according to claim 2, wherein, a connecting port is disposed inside the said bracket and that makes the said bracket connect with a computer via the said connecting port.

4. A bracket for a personal digital assistant (PDA) with the function of a digital camera according to claim 1, wherein, the said set of optical components comprises of a shutter, a lens and a view window, wherein, the said shutter is disposed on the holder section on the housing of the said bracket to allow the user's finger to touch and press the said shutter, the said lens is mounted on one lateral side on the housing of the said bracket, the said lens photographs the image into the said image capture control circuit to make the said image capture control circuit compile the photographed image to a digital signal, the said view window is disposed on the other lateral side of the said lens.

5. A bracket for a personal digital assistant (PDA) with the function of a digital camera according to claim 4, wherein, the said view window has an outer view window and an inner view window mounted respectively on the front and the rear sides of the said bracket, the said outer view window and the inner view window are communicated, thereby one of the user's eyes attaches closely to the said inner view window to view the object to be photographed outside the said outer view window.

6. A bracket for a personal digital assistant (PDA) with the function of a digital camera according to claim 4, wherein, the said image capture device also comprises of a flasher and a light sensitive component, the said flasher and the light sensitive component connect with the said image capture control circuit, the said flasher is disposed between the said lens and the said view window on the housing of the said bracket, the said light sensitive component is mounted on one lateral side adjacent to the said flasher to allow the said light sensitive component to test the light source around the object to be photographed and to enable the said image capture control circuit to receive the light sensitive signals of the said light sensitive component, thereby to control the said flasher to conduct the flashing to supplement enough light for the object to be photographed.

7. A bracket for a personal digital assistant (PDA) with the function of a digital camera according to claim 3, wherein, a supporting pedestal is pivotally mounted at the proper position on the back side of the said bracket, a stop component is mounted at the pivotal joint area between the said pedestal and the said bracket, the stopping of the said stop component on the said bracket permits the said pedestal to be only lifted outward to a proper angle, thereby the user can lift the said pedestal outward to make the said bracket stand on a flat plane through the supporting force of the said pedestal.
